(19) United States
(12) Patent Application Publication
(10) Pub. No.: US 2025/0199968 A1
(43) Pub. Date: Jun. 19, 2025

(54) PHYSICAL LAYER OF HIGH-SPEED MEMORY AND READ TRAINING METHOD OF HIGH-SPEED MEMORY

(71) Applicant: Electronics and Telecommunications Research Institute, Daejeon (KR)

(72) Inventors: Jaewoong CHOI, Daejeon (KR); Jin Ho HAN, Daejeon (KR); Young-Su KWON, Daejeon (KR)

(73) Assignee: Electronics and Telecommunications Research Institute, Daejeon (KR)

(21) Appl. No.: 18/985,647

(22) Filed: Dec. 18, 2024

(30) Foreign Application Priority Data
Dec. 19, 2023 (KR) 10-2023-0185899
Oct. 10, 2024 (KR) 10-2024-0137499

(51) Int. Cl. G06F 13/16

(52) U.S. Cl. CPC G06F 13/1668; G06F 2213/16

(57) ABSTRACT

The present embodiment provides a physical layer (PHY) between a high-speed memory and a memory controller, including: an analog physical layer including a read data strobe (RDQS) delay unit that delays an RDQS signal of the high-speed memory and outputs the delayed RDQS signal and a data (DQ) delay unit that delays DQ signals and outputs the delayed DQ signals; and a digital physical layer including an asynchronous first-in first-out (FIFO) that samples the DQ signal with the RDQS signal and outputs the DQ signal, a DQ arrangement block that rearranges the DQ signal, and a validity signal forming unit that forms a validity signal indicating validity of data from data output from the asynchronous FIFO, in which the analog physical layer receives a clock having the same frequency as the high-speed memory and operates, and the asynchronous FIFO and the validity signal forming unit receive a clock having a lower frequency than the clock provided to the high-speed memory and operate.

### CROSS-REFERENCE TO RELATED APPLICATION

This application claims priority to and the benefit of Korean Patent Application Nos. 10-2023-0185899, filed on Dec. 19, 2023 and 10-2024-0137499, filed on Oct. 10, 2024, the disclosures of which are incorporated herein by reference in its entirety.

### BACKGROUND

### 1. Field of the Invention

The present disclosure generally relates to a physical layer of a high-speed memory and a read training method of a high-speed memory.

### 2. Discussion of Related Art

In a high-speed memory, since data and data strobe signals enter and exit the memory through different ports, a time difference occurs between the signals, making it difficult to reliably read or write data in a transmitting or receiving unit. To compensate for the time difference caused by structural properties of the memory, a series of training is performed to reduce the time difference during a memory initialization process.

The read training process of the high-speed memory including high bandwidth memory 3(HBM3) refers to a process of adjusting the timing of data and strobe signals output from the memory to meet the timing requirements of HBM3, thereby enabling data output from the HBM3 memory to be read accurately and quickly at a high speed.

### SUMMARY OF THE INVENTION

A read training algorithm uses a read data strobe (RDQS) signal and a data (DQ) signal. Generally, the read training algorithm fetches a predetermined test pattern from a high bandwidth memory 3 (HBM3) memory, transmits the fetched test pattern to a controller, and checks whether the test pattern is received correctly to control the timing relationship.

In the read operation, the RDQS signal is output from the HBM3 memory, but a two-cycle long preamble is added to a head of the RDQS signal, and a postamble is added to the last two cycles of the RDQS signal. During the read training, a cleaning process is required to remove the preamble and postamble. A cleaning block that removes the preamble and postamble from the RDQS signal mainly includes blocks such as a receiver, a comparator, a gate signal generator, and a clean signal generator. Since the RDQS signal operates at a high frequency, the cleaning block should also operate at a high frequency, resulting in high power consumption. In addition, there is a disadvantage in that the read training time is long and the training becomes complicated.

The present embodiment is intended to solve difficulties in HBM3 memory read training.

According to an aspect of the present invention, there is provided a physical layer (PHY) between a high-speed memory and a memory controller, including: an analog physical layer including a read data strobe (RDQS) delay unit that delays an RDQS signal of the high-speed memory and outputs the delayed RDQS signal and a data (DQ) delay unit that delays DQ signals and outputs the delayed DQ signals; and a digital physical layer including a DQ arrangement unit that arranges the DQ signals, an asynchronous first-in first-out (FIFO) that samples the DQ signal with the RDQS signal and outputs the DQ signal in synchronization with a digital physical layer clock, and a validity signal forming unit that forms a validity signal indicating validity of data output from the asynchronous FIFO, in which the analog physical layer receives a clock having the same frequency as the high-speed memory and operates, and the asynchronous FIFO and the validity signal forming unit receive a clock having a lower frequency than the clock provided to the high-speed memory and operate.

The DQ arrangement unit may arrange the DQ signal by expanding a width of the DQ signal to correspond to a ratio of the frequency of the clock provided from the high-speed memory and a frequency of the digital physical layer and a data rate of the high-speed memory.

The RDQS delay unit may be a buffer line having a controllable delay, and the DQ delay unit may be the buffer line having the controllable delay.

The DQ signal may include a first DQ signal and a second DQ signal, and the digital physical layer may further include a DQ signal arrangement unit, and the DQ signal arrangement unit may arrange and output the DQ signals to correspond to a ratio of the frequency of the clock provided from the high-speed memory and a frequency of the digital physical layer and a data rate of the high-speed memory. The DQ signal arrangement unit may expand the width of the DQ signal to correspond to a product of the frequency ratio and the data rate and provide the DQ signal to the asynchronous FIFO.

The asynchronous FIFO may output a sampled signal by synchronizing the rearranged DQ signals with a digital physical layer clock.

The memory controller may generate an enable signal in the memory controller to check whether the signal output from the asynchronous FIFO corresponds to a training sequence stored in the memory controller, and the validity signal forming unit may delay a starting edge of the enable signal to correspond to a starting edge of the signal output from the asynchronous FIFO to generate the validity signal. The validity signal forming unit may control an edge of the validity signal to correspond to edges of the signals output from the asynchronous FIFO. The validity signal forming unit may be a register chain connected in cascade.

The high-speed memory may be an HBM3 memory.

According to an aspect of the present invention, there is provided a read training method of a high-speed memory, including: adjusting, by an analog physical layer, phases of a read data strobe (RDQS) signal and a data (DQ) signal; arranging the DQ signals to correspond to a ratio of a frequency of a high-speed memory clock and a frequency of a digital physical layer and a data rate of the high-speed memory; sampling, by an asynchronous first-in first-out (FIFO), the DQ signal with the RDQS signal and outputting the sampled signal to a digital physical layer clock; generating, by a controller of the high-speed memory, an enable signal according to a read command signal and outputting the generated enable signal to the physical layer; and delaying, by a validity signal forming unit, a starting edge of the enable signal output from a memory controller to correspond to a starting edge of the sampled DQ signal to form a validity signal indicating validity of the sampled signal.

The arranging of the DQ signals may be performed by expanding a width of the DQ signal to correspond to a product of the frequency ratio and the data rate.

The DQ signal may include a first DQ signal and a second DQ signal, and in the adjusting of the phases, the first DQ signal may be sampled with a rising or falling edge of the RDQS signal, and the second DQ signal may be sampled with a rising or falling edge of the RDQS signal.

In the sampling of the DQ signal by the asynchronous FIFO, the RDQS signal may be provided to the asynchronous FIFO to sample the DQ signal, and the sampled signal may be output in synchronization with a clock having a lower frequency than a clock provided to the high-speed memory.

In the outputting of the enable signal, when generating a read command for receiving a specific DQ signal, the controller may output an enable signal to check whether the read data corresponds to a stored training sequence. The validity signal forming unit may control an edge of the validity signal to correspond to the edge of the sampled DQ signal.

The validity signal forming unit may be a register chain connected in cascade. The validity signal forming unit may delay the starting edge of the enable signal to correspond to the starting edge of the sampled DQ signal to generate the validity signal.

The high-speed memory may be an HBM3 memory.

A preamble may be added to a head of the RDQS signal, and a postamble may be added to an end of the RDQS signal.

### BRIEF DESCRIPTION OF DRAWINGS

The above and other objects, features and advantages of the present invention will become more apparent to those of ordinary skill in the art by describing exemplary embodiments thereof in detail with reference to the accompanying drawings, in which:

FIG. 1 is a flowchart illustrating an outline of a read training method of a high-speed memory according to the present embodiment;

FIG. 2 is a block diagram illustrating an outline of a physical layer of the present embodiment;

FIG. 3 is a diagram illustrating a read data strobe (RDQS) signal output from an RDQS delay unit and a data (DQ) signal output from a DQ arrangement unit;

FIG. 4 is a diagram illustrating an outline of a validity signal forming unit;

FIG. 5 is a schematic timing diagram of a read training process according to an embodiment; and

FIG. 6 is a schematic timing diagram of a read training process according to another embodiment.

### DETAILED DESCRIPTION OF EXEMPLARY EMBODIMENTS

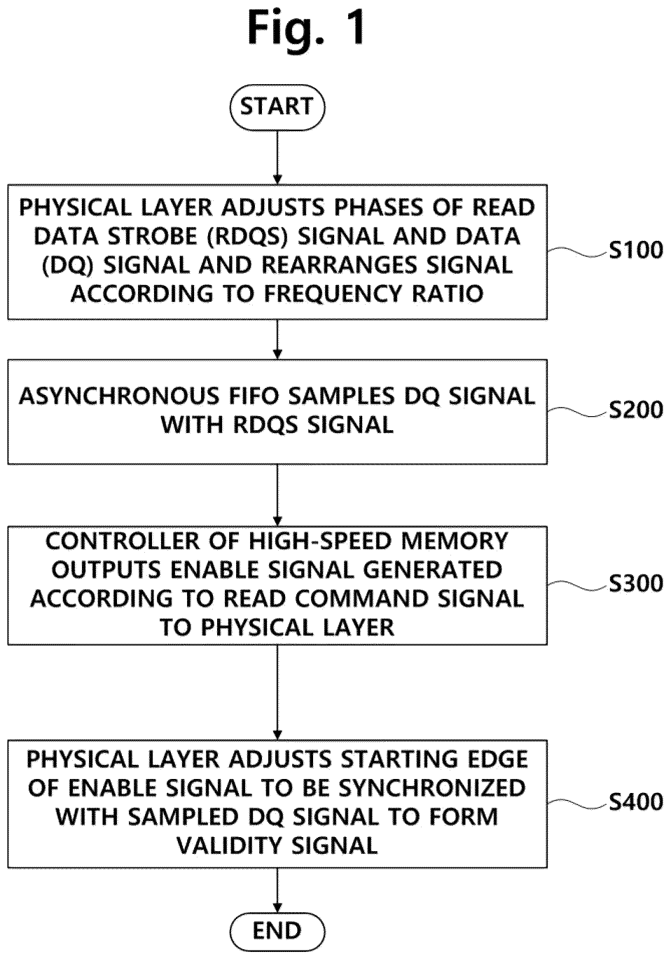

Hereinafter, the present embodiment will be described with reference to the accompanying drawings. FIG. 1 is a flowchart illustrating an outline of a read training method of a high-speed memory according to the present embodiment. Referring to FIG. 1, the read training method of the present embodiment includes an operation S100 in which a physical layer adjusts phases of a read data strobe (RDQS) signal and a data (DQ) signal and rearranges the signals, an operation S200 in which an asynchronous first-in first-output (FIFO) samples the DQ signal with the RDQS signal, an operation S300 in which a controller of the high-speed memory outputs an enable signal generated according to a read command signal to the physical layer, and an operation S400 in which the physical layer delays a starting edge of the enable signal to correspond to a starting edge of the sampled DQ signal to form a validity signal indicating validity of the sampled signal.

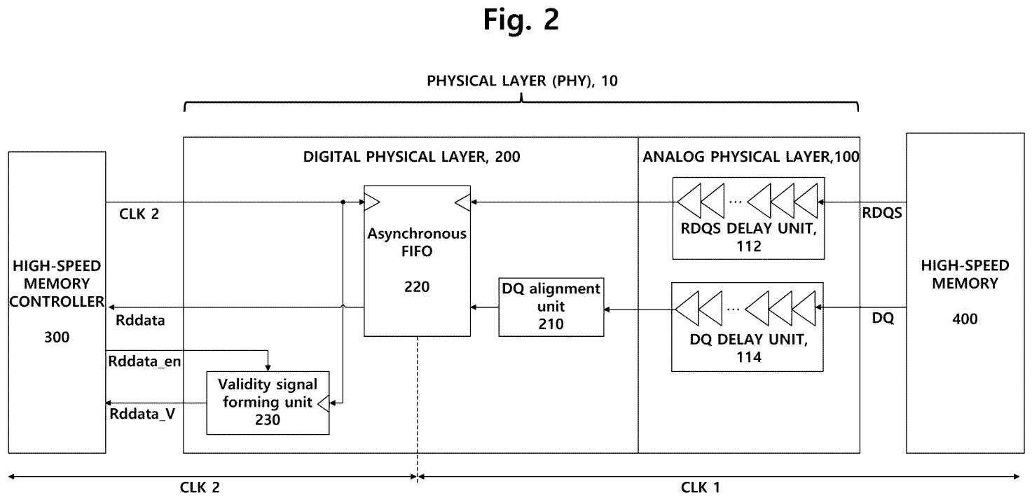

FIG. 2 is a block diagram illustrating an outline of a physical layer of the present embodiment. Referring to FIG. 2, a physical layer (PHY) 10 of the present embodiment provides a physical layer (PHY) between a high-speed memory 400 and a memory controller 300, and the physical layer (PHY) 10 includes an analog physical layer 100 including a read data strobe (RDQS) delay unit 112 that delays an RDQS signal of the high-speed memory 400 and outputs the delayed RDQS signal and a data (DQ) delay unit 114 that delays a DQ signal and outputs the delayed DQ signal; and a digital physical layer 200 including an asynchronous FIFO 220 that samples the DQ signal with the RDQS signal and outputs the DQ signal and a validity signal forming unit 230 that forms a validity signal Rddata_V indicating validity of data from data output from the asynchronous FIFO, in which the analog physical layer 100 receives a clock having the same frequency as the high-speed memory and operates, and the asynchronous FIFO 220 and the validity signal forming unit 230 receive a clock having a lower frequency than the frequency of the clock provided to the high-speed memory 400 and operate.

Hereinafter, the present embodiment will be described with reference to FIGS. 1 and 2. The RDQS signal provided from the high-speed memory 400 such as high bandwidth memory 3 (HBM3) is a signal that serves as a timing reference in a data reading process, and is transmitted from the memory to the physical layer 10 during the reading process. The DQ signal is actual data read from the memory. Since multiple channels are used simultaneously, the RDQS and DQ signals need to be trained for each channel.

In an embodiment, in the read training process, the DQ signal may be a training sequence determined in advance in relation to the high-speed memory controller 300. A controller of the high-speed memory may receive the DQ signal through a plurality of lines.

The RDQS signal RDQS and the DQ signal DQ output from the high-speed memory 400 are input to the RDQS delay unit 112 and the DQ delay unit 114 of the analog physical layer 100, respectively. The RDQS delay unit 112 and the DQ delay unit 114 receive the RDQS signal RDQS and the DQ signal DQ, respectively, and arrange timings of the RDQS signal RDQS and the DQ signal DQ.

In an embodiment, the RDQS delay unit 112 and the DQ delay unit 114 may each be delay buffers in which unit buffers delaying the input signal with a unit delay time are connected in cascade. For example, the RDQS delay unit 112 and the DQ delay unit 114 may control a voltage provided to the delay buffer to control the delay time (voltage-controlled delay), include a controllable switch to control the number of stages of the unit buffers, or include a capacitor having a controllable capacitance to control the delay time. However, these are only examples, and the present embodiment may be implemented by employing other delay buffers. The analog physical layer 100 receives a clock having the same frequency as a clock signal provided to the high-speed memory 400 and operates.

The conventional technology includes an RDQS cleaning block to remove a preamble and a postamble from the RDQS signal output from the high-speed memory, thereby performing RDQS cleaning. However, the RDQS cleaning block includes a receiver, a comparator, a gate generator, and a clean DQS generator that operate with a high-frequency clock. These cleaning blocks are included for each channel, resulting in high power consumption. However, unlike the related art, the present embodiment does not include the RDQS cleaning block, thereby reducing power consumption.

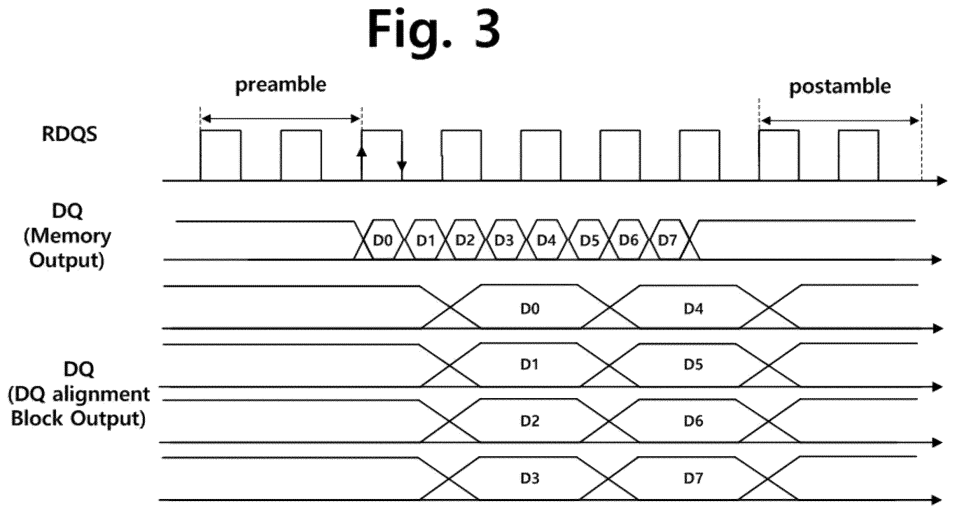

FIG. 3 is a diagram illustrating the RDQS signal output from the RDQS delay unit 112 and the DQ signal output from a DQ arrangement unit 210. In the embodiment illustrated in FIG. 3, the digital physical layer 200 may further include the DQ arrangement unit 210 that supports arrangement of DQ signals according to a frequency ratio. As an example, when a ratio of a frequency of the RDQS signal and a frequency of a second clock CLK2 is 2:1 and a data rate is a 2:1 double data rate, a first DQ signal DQ (even) (D0, D2, D4, and D6) and a second DQ signal DQ (odd) (D1, D3, D5, and D7) output from the memory may be aligned into a total of four signals by expanding a data width by four times (S100). Accordingly, when the ratio of the frequency of the RDQS signal and the frequency of the second clock CLK2 is k: 1 and the data rate is n: 1, the data width may be expanded by n×k times and aligned.

In the illustrated embodiment, the DQ delay unit 114 may adjust a phase of a first DQ signal DQ (even) (D0, D2, D4, and D6) so that the first DQ signal DQ (even) (D0, D2, D4, and D6) may be sampled at an edge of the RDQS signal. In addition, the DQ delay unit 114 may adjust the phase of the second DQ signal DQ (odd) (D1, D3, D5, and D7) so that the edge of the RDQS signal may sample the second DQ signal DQ (odd) (D1, D3, D5, and D7). In the illustrated embodiment, the edge of the RDQS signal may be a falling edge or a rising edge.

The aligned DQ and RDQS signals are provided to the asynchronous FIFO 220. The asynchronous FIFO 220 is an element used to transmit data between two different asynchronous clock domains. As illustrated in FIG. 2, the asynchronous FIFO 220 samples data with a first clock CLK 1 of a high frequency provided to the high-speed memory 400 and transmits the sampled data to the high-speed memory controller 300 in synchronization with a second clock CLK 2 of a relatively low frequency (S200).

As described above, the asynchronous FIFO 220 transmits the sampled data to the high-speed memory controller 300 in synchronization with the second clock CLK 2. In the memory read training process, the data provided to the high-speed memory controller 300 may be a training sequence stored in both the memory controller 300 and the high-speed memory 400.

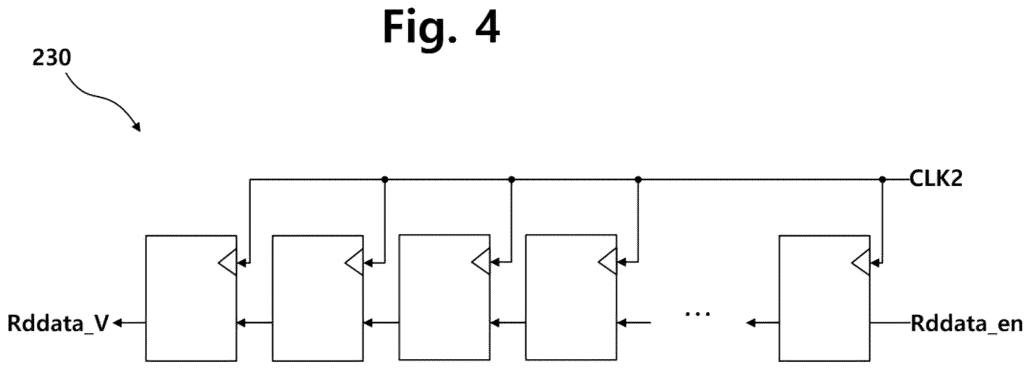

The memory controller 300 outputs a read data enable signal Rddata_en to check whether read data Rddata output from the asynchronous FIFO 220 corresponds to the stored training sequence (S300). FIG. 4 is a diagram illustrating an outline of the validity signal forming unit 230. Referring to FIG. 4, the validity signal forming unit 230 includes a register chain connected in cascade. The second clock CLK signal is provided to registers belonging to the register chain, and the read data enable signal Rddata_en is input and propagates through the register chain according to the second clock CLK signal to be output as a read data validity signal Rddata_V.

The validity signal forming unit 230 receives the read data enable signal Rddata_en input from the memory controller 300 and outputs the read data enable signal Rddata_en in synchronization with the output of the read data Rddata signal.

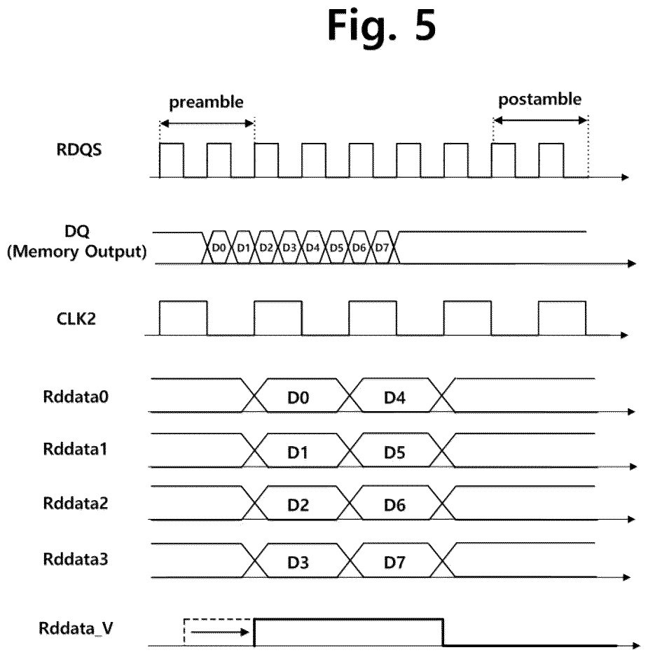

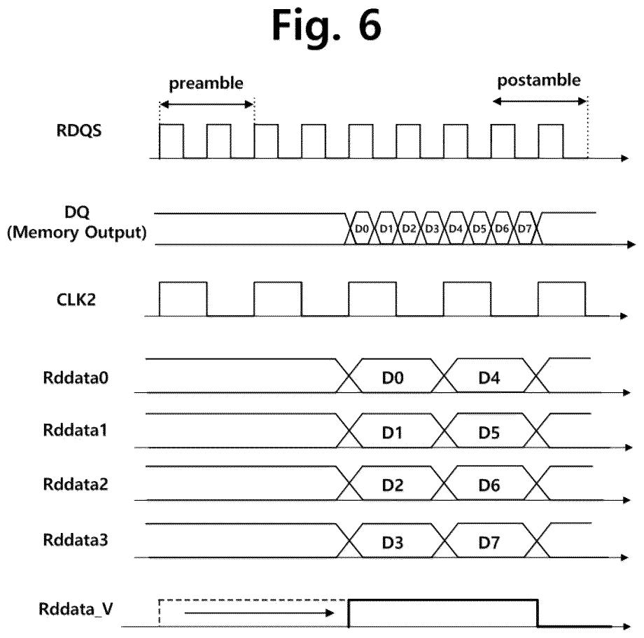

Hereinafter, an outline of the read training method of the present embodiment will be described with reference to FIGS. 5 and 6. FIGS. 5 and 6 are schematic timing diagrams of the read training process of the present embodiment, and the training process of the present embodiment will be described with reference to the timing diagrams. The RDQS signal includes a preamble of two cycles and a postamble of two cycles. In the DQ arrangement unit 210, the DQ signals are rearranged into DQ0, DQ1, DQ2, and DQ3 in proportion to the ratio of the frequency of the high-speed memory and the frequency of the digital physical layer, and the asynchronous FIFO 220 samples the DQ signals DQ0, DQ1, DQ2, and DQ3 with the input RDQS signal.

The asynchronous FIFO 220 samples the DQ signals DQ0, DQ1, DQ2, and DQ3 with the second clock CLK2 to output read data Rddata0, Rddata1, Rddata2, and Rddata3. In the read training process, the high-speed memory controller 300 generates the read data enable signal Rddata_en to determine whether the read data Rddata0, Rddata1, Rddata2, and Rddata3 corresponds to the training sequence.

The validity signal forming unit 230 receives the read data enable signal Rddata_en and outputs the validity signal Rddata_V indicating a section in which the read data is valid. In an embodiment, the validity signal forming unit 230 delays the read data enable signal Rddata_en and outputs the delayed read data enable signal Rddata_en so that the validity signal Rddata_V is output in synchronization with an edge of the clock signal at which the valid read data Rddata0, Rddata1, Rddata2, and Rddata3 is output, and when the section in which the read data Read data 0, Read data 1, Read data 2, and Read data 3 is valid ends, forms a falling edge of the validity signal Rddata_V in synchronization with the clock signal.

In the related art, the preamble and postamble of the RDQS signal was removed. As illustrated in FIG. 5, when the timings of the DQ signals DQ (even) and DQ (odd) are not aligned and thus invade a preamble area, the DQ signals DQ (even) and DQ (odd) should be delayed until the filtered RDQS edge at which the DQ signals may be sampled so that the DQ signals DQ (even) and DQ (odd) may be sampled with the filtered RDQS signals. It took a long time to solve this timing problem, resulting in large power consumption.

However, according to the present embodiment, since the validity signal Rddata_V indicates the section in which the read data Read data 0, Read data 1, Read data 2, and Read data 3 is valid, it is possible to know the section in which the read data Read data 0, Read data 1, Read data 2, and Read data 3 may be sampled validly without the cleaning process, thereby overcoming the difficulties of the related art.

Also, as illustrated in FIG. 6, when the timings of the DQ signals DQ (even) (D0, D2, D4, and D6) and DQ (odd) (D1, D3, D5, and D7) are not aligned and invade the postamble area of the RDQS signal, the filtered RDQS signal should be pushed to the edge of DQ signals DQ (even) (D0, D2, D4, and D6) and DQ (odd) (D1, D3, D5, and D7) at which the DQ signals may be sampled with the filtered RDQS signals. It took a long time to solve this timing problem, resulting in large power consumption.

However, according to the present embodiment, since the validity signal Rddata_V indicates the section in which the read data Read data 0, Read data 1, Read data 2, and Read data 3 is valid, it is possible to know the section in which the read data Read data 0, Read data 1, Read data 2, and Read data 3 may be sampled validly without the cleaning process, thereby overcoming the difficulties of the related art.

According to an embodiment of the present disclosure, it is possible to simplify the design and reduce the area and power consumption by not removing the preamble and postamble added to the RDQS signal.

Although the present disclosure has been described with reference to embodiments illustrated in the accompanying drawings in order to help the understanding of the present disclosure, this is only an exemplary embodiment for implementation, and those of ordinary skill in the art will understand that various modifications and other equivalent embodiments are possible therefrom. Accordingly, the true technical scope of the present disclosure is to be determined from the spirit of the appended claims.

What is claimed is:

1. A physical layer (PHY) between a high-speed memory and a memory controller, the physical layer comprising:
an analog physical layer including a read data strobe (RDQS) delay unit that delays an RDQS signal of the high-speed memory and outputs the RDQS signal and a data (DQ) delay unit that delays DQ signals and outputs the delayed DQ signals; and
a digital physical layer including a DQ arrangement unit that arranges the DQ signals, an asynchronous first-in first-out (FIFO) that samples the DQ signal with the RDQS signal and outputs the DQ signal in synchronization with a digital physical layer clock, and a validity signal forming unit that forms a validity signal indicating validity of data output from the asynchronous FIFO,
wherein the analog physical layer receives a clock having the same frequency as the high-speed memory and operates, and
the asynchronous FIFO and the validity signal forming unit receive a clock having a lower frequency than the clock provided to the high-speed memory and operate.

2. The physical layer of claim 1, wherein the DQ arrangement unit arranges the DQ signals by expanding a width of the DQ signal to correspond to a ratio of the frequency of the clock provided from the high-speed memory and a frequency of the digital physical layer and a data rate of the high-speed memory.

3. The physical layer of claim 1, wherein the RDQS delay unit is a buffer line having a controllable delay, and
the DQ delay unit is the buffer line having the controllable delay.

4. The physical layer of claim 1, wherein the DQ signals include a first DQ signal and a second DQ signal, and
the digital physical layer further includes a DQ signal arrangement unit, and the DQ signal arrangement unit arranges the DQ signals and outputs the arranged DQ signals to correspond to a ratio of the frequency of the clock provided from the high-speed memory and a frequency of the digital physical layer and a data rate of the high-speed memory.

5. The physical layer of claim 4, wherein the DQ signal arrangement unit expands the width of the DQ signal to correspond to a product of the frequency ratio and the data rate and provides the DQ signal to the asynchronous FIFO.

6. The physical layer of claim 1, wherein the asynchronous FIFO outputs a sampled signal by synchronizing the rearranged DQ signals with a digital physical layer clock.

7. The physical layer of claim 1, wherein the memory controller generates an enable signal in the memory controller to check whether the signal output from the asynchronous FIFO corresponds to a training sequence stored in the memory controller, and
the validity signal forming unit delays a starting edge of the enable signal to correspond to a starting edge of the signal output from the asynchronous FIFO to generate the validity signal.

8. The physical layer of claim 7, wherein the validity signal forming unit controls an edge of the validity signal to correspond to edges of the signals output from the asynchronous FIFO.

9. The physical layer of claim 7, wherein the validity signal forming unit is a register chain connected in cascade.

10. The physical layer of claim 1, wherein the high-speed memory is a high bandwidth memory 3 (HBM3) memory.

11. A read training method of a high-speed memory, the read training method comprising:
adjusting, by an analog physical layer, phases of a read data strobe (RDQS) signal and data (DQ) signals;
arranging the DQ signals to correspond to a ratio of a frequency of a high-speed memory clock and a frequency of a digital physical layer and a data rate of the high-speed memory;
sampling, by an asynchronous first-in first-out (FIFO), the DQ signal with the RDQS signal and outputting the sampled signal to a digital physical layer clock;
generating, by a controller of the high-speed memory, an enable signal according to a read command signal and outputting the generated enable signal to the physical layer; and
delaying, by a validity signal forming unit, a starting edge of the enable signal output from a memory controller to correspond to a starting edge of the sampled DQ signal to form a validity signal indicating validity of the sampled signal.

12. The read training method of claim 11, wherein the arranging of the DQ signals is performed by expanding a width of the DQ signal to correspond to a product of the frequency ratio and the data rate.

13. The read training method of claim 11, wherein the DQ signals includes a first DQ signal and a second DQ signal, and
in the adjusting of the phases,
the first DQ signal is sampled with a rising or falling edge of the RDQS signal, and
the second DQ signal is sampled with a rising or falling edge of the RDQS signal.

14. The read training method of claim 11, wherein, in the sampling of the DQ signal by the asynchronous FIFO,
the RDQS signal is provided to the asynchronous FIFO to sample the DQ signal, and
the sampled signal is output in synchronization with a clock having a lower frequency than a clock provided to the high-speed memory.

15. The read training method of claim 11, wherein, in the outputting of the enable signal, when generating a read command for receiving a specific DQ signal, the controller outputs an enable signal to check whether the read data corresponds to a stored training sequence.

16. The read training method of claim 15, wherein the validity signal forming unit controls an edge of the validity signal to correspond to the edge of the sampled DQ signal.

17. The read training method of claim 11, wherein the validity signal forming unit is a register chain connected in cascade.

18. The read training method of claim 17, wherein the validity signal forming unit delays the starting edge of the enable signal to correspond to the starting edge of the sampled DQ signal to generate the validity signal.

19. The read training method of claim 11, wherein the high-speed memory is a high bandwidth memory 3 (HBM3) memory.

20. The read training method of claim 11, wherein a preamble is added to a head of the RDQS signal, and
a postamble is added to an end of the RDQS signal.
